(19) United States
(12) Patent Application Publication
(10) Pub. No.: US 2012/0284766 A1
(43) Pub. Date: Nov. 8, 2012

(54) BAND-STOP FILTER

(76) Inventors: Dominique Lo Hine Tong, Rennes (FR); Jean-Yves Le Naour, Pace (FR); Jean-Luc Robert, Betton (FR); Ali Louzir, Rennes (FR)

(21) Appl. No.: 13/459,656

(22) Filed: Apr. 30, 2012

(30) Foreign Application Priority Data
May 5, 2011 (FR) 1153855

(51) Int. Cl. H04N 21/61

(52) U.S. Cl. 725/149

(57) ABSTRACT

The present invention relates to a band rejection filter. The band rejection filter includes a first signal transmission channel called a direct channel and a second signal transmission channel called a secondary channel. The direct channel and the secondary channel being designed to introduce at a first rejection frequency a phase difference of 180° between the signal circulating via the direct channel and the signal circulating via the secondary channel. Additionally, the secondary channel includes a filtering element for which the cut-off frequency is different from the first rejection frequency in a way to create a second rejection frequency.

### DOMAIN OF THE INVENTION

The present invention relates to an improvement to the band-rejection or band-stop filter, more specifically a band-rejection filter having simultaneously two rejection frequencies. The invention applies particularly in multi-standard multi-mode user terminals and in transmission and/or reception systems compliant with the standards DVB-H (Digital Video Broadcasting-Handheld) or DVB-T (Digital Video Broadcasting Terrestrial).

### TECHNICAL BACKGROUND

User terminals that integrate several radio-communications systems are naturally subject to interferences due to the congestion of the frequencies spectrum by systems operating in frequency bands that are more and more close to each other or due to the size more and more reduced of these terminals, that means that the radio antennas used for transmission, particularly for radio-communications, are physically closer and closer creating as a result interference coupling that is harmful to the system. To overcome these disadvantages ultra selective filters are used, these filters making the systems immune to interferences.

Thus, it has already been proposed in order to filter interference signals to use an appropriate band-rejection filter or a band-stop filter such as the filter discussed, for example, in the document titled “Exact Synthesis of Microwave Filters with Non-uniform Dissipation” by C. Guyette et al, IEEE-IMS-2007. Moreover, in the French patent application published under the number 2947683 in the name of THOMSON Licensing, an improvement to the band-rejection filter initially described in the article by Guyette et al was also proposed. A filter of this type is shown in FIG. 1. It comprises between a filter input 1 and a filter output 2, a first signal transmission channel 3, called a direct channel, to which is coupled a second signal transmission channel 4, called a secondary channel. These two channels 3 and 4 are produced via transmission lines called micro-strip lines, as these lines are printed onto a substrate. The secondary path 4 forms a resonant line for which the length lr is a function of λ/2, giving a resonance frequency that corresponds to the frequency to signals to be rejected. The direct path 3 and the secondary path 4 are coupled together on a line length ls at the input 1 and the output 2 of the filter. The topology of the filter is defined so that, at the resonance frequency, the signal from the direct channel 3 and that from the secondary channel 4 combine in phase opposition at the filter output creating as a result an attenuation that is theoretically infinite in a band that is relatively narrow around the resonance frequency. This structure thus enables significant rejection levels to be obtained but at the cost of an increase in insertion losses, the level of losses depending on the quality factor of the resonating element.

A band-rejection filter as described above was simulated taking into consideration a micro-strip type line technology with the following parameters:

The substrate selected is an Fr 4 substrate of thickness 0.25 mm and Er=4.5.

The width of micro-strip line sis such that W=0.44 mm to have a characteristic impedance of 50 ohms.

The lines coupled on a length ls are selected such that s=100 μm and ls=18.2 mm, s representing the distance between the two lines.

The length of the main line 3=2×ls+lp, with lp=72 mm and the length of the resonant line 4 =2*×ls+lr.

In FIG. 2 is shown the response in transmission of the filter for 3 values of lr namely lr=44 mm,60 mm and 80 mm. This simulation shows, in particular, that there is obtained with this filter structure, a significant attenuation over a relatively wide frequency band. It can thus be deduced that the level of attenuation is not very sensitive to a variation in the phase difference between the main channel and the secondary channel.

### BRIEF DESCRIPTION OF THE INVENTION

The present invention consists in using the properties of Guyette type band-rejection filters to produce a filter structure able to have simultaneously two band cut response types, namely two rejection frequencies, that is both compact and with little loss.

The purpose of the present invention is thus a band-rejection filter comprising a filter input and a filter output,
a first signal transmission channel, called the direct channel and a second transmission channel called the secondary channel arranged between said filter input and said filter output and coupled between them at the filter input and the filter output,
said direct channel and said secondary channel each comprising at least one transmission line,
the secondary channel comprising a resonant element for which the resonance frequency is equal to a frequency called the first rejection frequency,
the direct channel and the secondary channel being designed to introduce at the rejection frequency a phase difference of 180° between the signal circulating via the direct channel and the signal circulating via the secondary channel,
characterized in that the secondary channel comprises in addition a filtering element for which the cut-off frequency is different from said first rejection frequency in a way to create a second rejection frequency.

Thus is obtained with a single filter the possibility to simultaneously reject two interfering signals located close to a useful frequency band.

According to a first embodiment, the filtering element is a low-pass filter for which the cut-off frequency is greater than the first rejection frequency of the filter. The low-pass filter is preferably constituted of at least two self-inductances in series on the secondary channel and at least one capacitor mounted between the self-inductances and a ground point, the value of self-inductances and the capacitor determining the cut-off frequency of the filter.

According to a second embodiment, the filtering element is a high-pass filter for which the cut-off frequency is less than the first rejection frequency of the filter. The high-pass filter is preferably constituted of at least two capacitors in series on the secondary channel and at least one self-inductance mounted between the capacitors and a ground point, the value of self-inductances and the value of capacitors determining the cut-off frequency of the filter.

According to another characteristic of the present invention, the first and/or second rejection frequencies can be modified by modifying the value of self-inductances and/or capacities of filtering elements. Thus it is possible to dynamically assign a rejection frequency without interfering with the other by working on one of the components of the filtering element. It is also possible to dynamically tune the two rejection frequencies at the same time by working on the values of different components of filtering elements.

### BRIEF DESCRIPTION OF THE FIGURES

Other characteristics and advantages of the present invention will emerge upon reading the following description made with reference to the annexed drawings, wherein:

FIG. 1, already described, shows a structure of a band-rejection filter according to the prior art,

FIG. 2, already described, shows a diagram showing the response of the filter of FIG. 1 for different resonant line lengths.

FIG. 3 shows a first embodiment of a band-rejection filter with two rejection frequencies, according to the present invention.

FIGS. 4a and 4b show a diagram giving the response in transmission of the filter of FIG. 3 for two different values of the capacity.

FIG. 5 shows a diagram giving the response of the filter of FIG. 3 for the value of different self-inductances.

FIG. 6 shows a second embodiment of a band-rejection filter with two rejection frequencies, according to the present invention.

FIGS. 7A and 7b each show a diagram giving the response in transmission of the filter of FIG. 6 for two different values of the self-inductances.

To simplify the description, in the figures, the same elements have the same references.

### DETAILED DESCRIPTION OF SEVERAL EMBODIMENTS

A description will first be given, with reference to FIGS. 3 to 5, of a first embodiment of band-rejection filter in accordance with the present invention. As shown in FIG. 3, the band-rejection filter comprises a filter input 1 and a filter output 2. It also comprises a signal transmission channel 3 called a direct channel and a signal transmission channel 4 called a secondary channel. These two channels are located between the filter input 1 and the filter output 2. In the embodiment shown, the channels 3 and 4 are produced by micro-strip lines printed on a dielectric substrate. Moreover, as in the case of the filter shown in FIG. 1, the direct channel 3 and the secondary channel 4 are coupled together at the input and output of the filter. To do this, a part of the line 3′ of the direct channel and a part of the line 4 of the secondary channel are arranged parallel to each other and close to one another in a way to create an electromagnetic coupling between the direct channel 3 and the secondary channel 4 at the input of the filter. Likewise, a part of the line 3″ of the direct channel 3 and a part of the line 4″ of the secondary channel are arranged parallel to each other and close to one another in a way to create an electromagnetic coupling between the direct channel 3 and the secondary channel 4 at the output of the filter. In the example of FIG. 3, the dimensions of line parts 4′,3′, 4″, 3″ are identical and the distance between said line parts at the input and at the output are the same so that the coupling is the same at the input and the output of the filter.

The length of line elements constituting the direct channel 3 and the secondary channel 4 is determined so as to introduce at the rejection frequency a phase difference of 180° between the signal circulating via the direct channel 3 and the signal circulating via the secondary channel 4.

In accordance with the present invention, on the secondary channel 4 is integrated a filtering element 5 that, in this embodiment, is constituted by a low-pass filter. More specifically and as shown in FIG. 3, the low-pass filter 5 is constituted of two inductances or self-inductances 5a, 5b of value La mounted in series on the secondary channel 4 and a capacity 5c of value Ca mounted between the junction point of two inductances 5a, 5b and a ground point. It involves a low-pass filter of the order of 3 produced with discrete components. It is evident to those skilled in the art that the low-pass filter can also be produced using distributed technology such as transmission lines and/or that it can be of a higher order.

The filter of FIG. 3 was simulated using as a substrate and as dimensions for the transmission lines, the elements used for the simulation of the filter of FIG. 1. Moreover, the following parameters were taken into account:

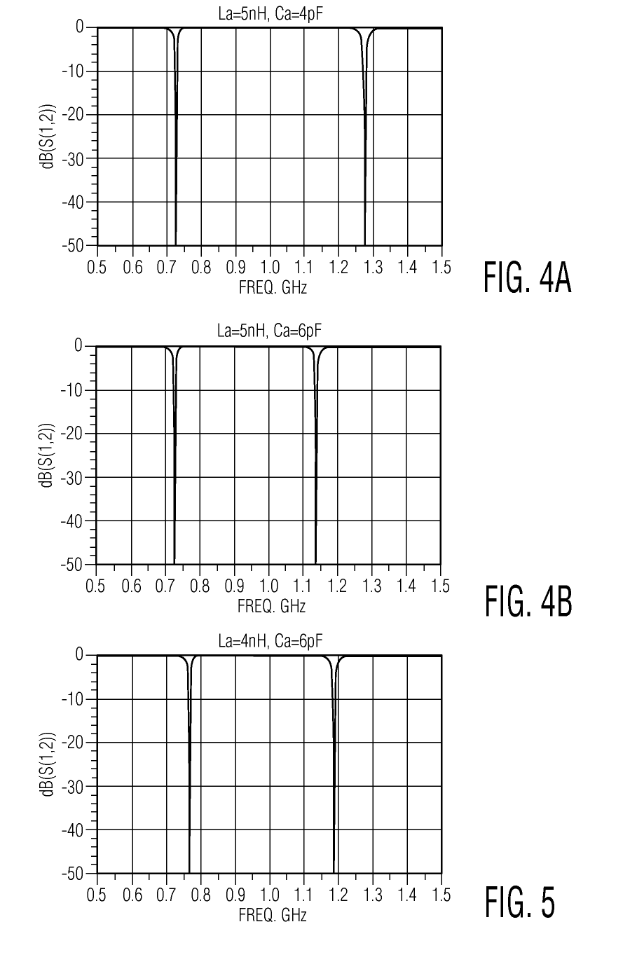

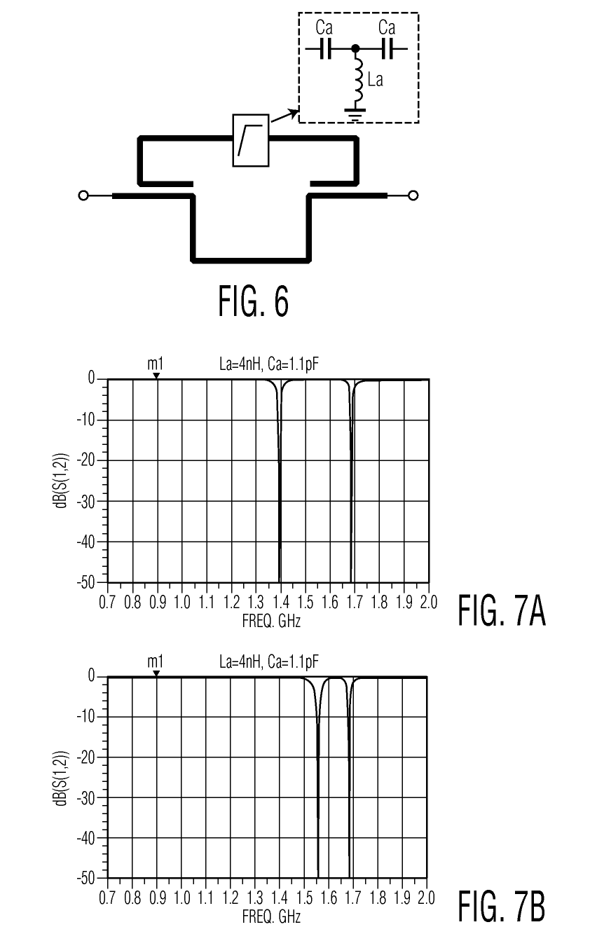

The simulation was made with a value lr=44 mm. The two inductances 5a, 5b have values La=SnH and the capacitor 5c has a value Ca=4 pF for FIG. 4A and 6 pF for FIG. 4B. Moreover, an additional simulation was carried out with a self-inductance value of La=4 nH and a capacity value Ca=6 pF, the results of the simulation being given in FIG. 5.

In FIG. 4A, is shown the response of the filter for inductance values La=5 nH and capacity Ca=4 pF. The curve shown represents the presence of two rejection frequencies, one around 730 MHz and the other at around 1270 MHz.

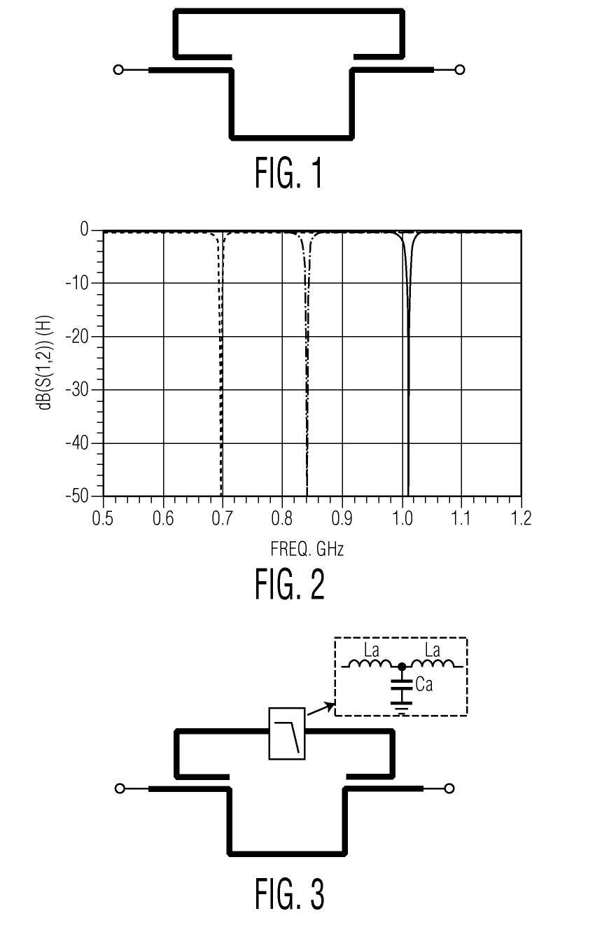

If the curve of FIG. 5 is compared with the curves of FIG. 2, it can be seen that the low-pass filter integrated at the secondary channel 4 introduces a positive phase difference that results in a shift in the resonance frequency of the initial filter shown in FIG. 1. Thus the initial frequency that was at around 1010 MHz has passed to 730 MHz, which corresponds to the first rejection frequency.

Moreover, if the value Ca of the capacity is increased by 2 Pico farads, that is Ca=6 picofarads, FIG. 4B giving the response of the filter shows that the low resonance frequency remains unchanged though the high resonance frequency passes to approximately 1137 MHz. In addition, if the inductance value La is modified to 4 nH for a capacity Ca=6 pF, it can be noted as shown in FIG. 5 that the two resonance frequencies, namely the first rejection frequency and the second rejection frequency, are both offset to high frequencies, the first rejection frequency being located at approximately 770 MHz and the second rejection frequency being located at approximately 1190 MHz.

Thus the filter structure shown in FIG. 3 has the following advantages:
possibility to assign a single resonance frequency by variation only of the value Ca of the capacity,
possibility to assign two resonance frequencies by modification of the values La and Ca of self-inductances and the capacity.

In practice, to produce a dynamic assignment according to the interference situations that the multi-radio terminal must confront, the low-pass filter can be produced using for the capacity a varactor diode and for the self-inductance, an active inductance based on a transistor.

A description will now be given, with reference to FIGS. 6, 7A and 7B of a second embodiment of a rejection filter in accordance with the present invention. As shown in FIG. 6, the basic structure of the rejection filter is identical to the basic structure of the rejection filter of FIG. 3. Consequently, the basic structure will not be described again hereafter. In accordance with the second embodiment of the present invention, a filtering element 6 constituted by a high-pass filter is integrated into the secondary channel 4. More specifically the high-pass filter 6 is formed from two capacitor elements 6a, 6b of value Ca mounted in series on the secondary channel and an inductor element or self-inductance 6c of value La mounted between the point of junction of two capacitor elements and a ground point.

The embodiment of FIG. 6 was simulated by taking as a value of the basic structure the values of the rejection filter shown in FIG. 1. Moreover, the secondary channel has a length Lr=44 mm. The high-pass filter was simulated with capacity values Ca=11 pF and for the self-inductance value La=4 nH or La=2 nH.

In this case, the high-pass filter 6 introduces a negative phase difference and its insertion into the secondary channel 4 offsets the resonance frequencies of the band-rejection filter to higher frequencies. As shown in FIGS. 7A and 7B that show the response of the filter of FIG. 6, it can be seen that the integration of a high-pass filter 6 in the secondary channel causes two resonance frequencies to appear namely, a first and a second rejection frequency.

As shown in FIGS. 7A and 7B, it can be seen that the variation of the value of the self-inductance from 4 nH (FIG. 7A) to 2 nH (FIG. 7B) does not cause variation in the second rejection frequency that remains constant at approximately 1.7 GHz.

This can be explained by the fact that at the high resonance frequency, the self-inductance has a strong impedance and a minor variation of its value La does not change the conditions of this resonance, while at a low resonance frequency, the self inductance participates in the resonance circuit, that is checked by the value of the first rejection frequency that is located at 1.4 GHz in the case of FIG. 7A and at approximately 1.55 GHz in the case of FIG. 7B.

In the embodiment of FIG. 6, the high pass filter 6a was described using discreet elements. However it is clear to those skilled in the art that the filter can also be produced using transmission line type elements. The high-pass filter described is a filter of the order 3. However, this filter can also be of a higher order.

Though the invention has been described in relation to a specific embodiment, it is evident that this is in no way restricted and that it comprises all technical equivalents of the means described as well as their combinations if these enter into the scope of the invention.

What is claimed is:

1. Band-rejection filter comprising:
a filter input and a filter output,
a first signal transmission channel, called the direct channel, and a second signal transmission channel, called the secondary channel, located between said filter input and said filter output and coupled together at the filter input and the filter output, said direct channel and secondary channel each comprising at least one transmission line,
the secondary channel comprising a resonant element for which the resonance frequency is equal to a frequency to be rejected, called the first rejection frequency,
the direct channel and the secondary channel being designed to introduce at the rejection frequency a phase difference of 180° between the signal circulating via the direct channel and the signal circulating via the secondary channel,
wherein the secondary channel comprises in addition a filtering element for which the cut-off frequency is different from said first rejection frequency in a way to create a second rejection frequency distinct from said first rejection frequency.

2. Band-rejection filter according to claim 1, wherein the filtering element is a low-pass filter for which the cut-off frequency is greater than the first rejection frequency of the filter.

3. Band-rejection filter according to claim 2, wherein the low-pass filter is constituted by at least two self-inductances in series on the secondary channel and at least one capacity mounted between self-inductances and a ground point, the value of self-inductances and capacity determining the cut-off frequency of the filter.

4. Band-rejection filter according to claim 1, wherein the filtering element is a high-pass filter for which the cut-off frequency is less than the first rejection frequency of the filter.

5. Band-rejection filter according to claim 4, wherein the high-pass filter is constituted by at least two capacities in series on the secondary channel and at least one self-inductance mounted between capacities and a ground point, the value of self-inductances and capacity determining the cut-off frequency of the filter.

6. Band-rejection filter according to claim 3, wherein the first and/or second rejection frequencies can be modified by modifying the value of self-inductances and/or capacities of filtering elements.

7. Band-rejection filter according to claim 1, wherein the resonant element of the secondary channel is constituted by a resonant line of length λ/2, λ being the wavelength of the resonance frequency.

8. Multi-standard multi-mode terminal, comprising a band-rejection filter according to claim 1.
